(19) United States
(12) Patent Application Publication
(10) Pub. No.: US 2007/0172333 A1
(43) Pub. Date: Jul. 26, 2007

(54) SCREW MEMBER HAVING TWO DIFFERENT THREAD ANGLES FORMED ON A SHARP-EDGED THREAD

(76) Inventor: Tian-Fu Tsau, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/426,653

(22) Filed: Jun. 27, 2006

(30) Foreign Application Priority Data
Jan. 9, 2006 (TW) 095200463

(51) Int. Cl. F16B 33/00

(52) U.S. Cl. 411/378

(57) ABSTRACT

A screw member comprises a screw shank portion and a thread portion provided thereon. The screw shank portion has a bottom end formed with a tapered section, and a top end formed with a screw head portion. The thread portion is provided on an outer circumference of the screw shank portion. The thread portion includes a first thread section proximate the tapered section, and a second thread section proximate the screw head portion. The first thread section has a first thread angle of a sharp-edged thread smaller than a second thread angle of the second thread section such that the first thread section is easier to cut a rigid material.

### BACKGROUND OF THE INVENTION

1. Field of the Invention

The present invention relates to a screw member having two different thread angles of a sharp-edged thread. More particularly, the present invention relates to the two different thread angles of the screw member formed on the sharp-edged thread for easy drilling operation.

2. Description of the Related Art

A conventional screw member, as shown in FIG. 1, includes a screw shank portion 1 and a thread portion 2 provided thereon. Typically, the screw shank portion 1 is of a rod-like or stick-like member having a bottom end formed with a tapered section 11, and a top end formed with a screw head portion 12. The tapered section 11 is further formed with a sharp tip 111 for digging a surface of a wood plank, an object or a sheetmetal. Generally, the screw head portion 12 has a recessed structure of an actuating slot or socket 121 for receiving a tip of a tool member (not shown) in screwing operation. The actuating slot or socket 121 can receive various types of the tips of the screwdrivers, including a flat tip, a cross-headed tip and a square-headed tip etc. By way of example, a screwdriver or the like can be used to rotate the screw member in inserting (i.e. tightening) into a screw hole or removing (i.e. loosening) it from the screw hole.

Still referring to FIG. 1, integrally formed on the screw shank portion 1 is the thread portion 2 which extends along an outer circumference of the screw shank portion 1. The thread portion 2 is in the form of spiral and is used to cut the wood plank or sheetmetal (not shown) in drilling operation. Typically, the thread portion 2 has an upper cutting surface and a lower cutting surface that constitute a sharp-edged thread of the thread portion 2. Preferably, an included angle formed between extended lines (i.e. dotted lines in FIG. 1) of the upper cutting surface and lower cutting surface is 60 degrees with respect to the sharp-edged thread of the screw member. It will be further understood that the included angle formed between the extended lines of the upper cutting surface and lower cutting surface will be known as “thread angle”. It will be further understood that the sharp-edged thread of the screw member also has an inclination with respect to an axis of the screw shank portion 1.

In drilling operation, the sharp tip 111 of the screw member is engaged on a predetermined position of the surface of the plank, and the actuating slot or socket 121 of the screw member is further engaged with the tip of the screwdriver. The sharp tip 111 of the screw member may cause an initially drilling effect on the surface of the plank when starting to press and rotate the screw member. Once a predetermined length of the tapered section of the screw member is completely inserted into the plank, the thread portion 2 may engage with the surface of the plank. Thus the sharp-edged thread of the thread portion 2 can cut the surface of the plank by further rotating the screw member. The screw member can be further rotated and completely inserted into the surface of the plank such that a screwing operation is carried out. Conversely, the screw member can be rotated in a reverse direction such that an unscrewing operation is carried out.

With regard to the problematic aspect generally occurring during use of the conventional screw member, the thread portion 2 is susceptible to a number of problems as described more fully below. In drilling operation, the primary problem with such a conventional screw member is due to the fact that the sharp-edged thread of the thread portion 2 functions as a blade to cut the material of the plank so as to allow insertion of the screw shank portion 1 into the plank. However, the thread angle of the sharp-edged thread of the thread portion 2 with respect to the surface of the plank is too large such that a greater force must be exerted on the screw member so as to allow the sharp-edged thread cutting the material of the plank. In the highly rigid material of the plank, a small increase in the thread angle of the thread portion 2 can result in a significant effect on the force exerted on the screw member in drilling operation. Accordingly, there is a need for actuating the screw member with greater exertions in drilling the plank.

The problem with the greater exertions during drilling the plank is a tilt of the screw member to the surface of the door plank. Moreover, the tilt of the screw member may cause a bulging or cracking effect on the surface of the plank such that the quality of screwing the screw member on the plank is poor. Another problem with the use such a conventional screw member is susceptible to damage to the structure of the screw member due to extremely greater stress exerting on the screw head portion 12. Hence, there is a need for improving the structure of the screw member.

As is described in greater detail below, the present invention intends to provide a screw member having a first thread angle and a second thread angle formed on a sharp-edged thread for easy drilling operation. The first thread angle is proximate a sharp tip, and smaller than the second thread angle such that the first thread angle is easier to cut a rigid material. The screw member is easer to be inserted into the material in such a way to mitigate and overcome the above problem.

### SUMMARY OF THE INVENTION

The primary objective of this invention is to provide a screw member having two different thread angles formed on a sharp-edged thread for easy drilling operation. A first thread angle of a first thread section is proximate a sharp tip, and smaller than a second thread angle of a second thread section such that the first thread section is easier to cut a rigid material. Accordingly, the work efficiency for screwing the screw member is increased.

The secondary objective of this invention is to provide the screw member having two different thread angles formed on the sharp-edged thread, wherein the first thread section has a thickness thinner than that of the second thread section such that the first thread section is easier to cut a rigid material. Accordingly, the work efficiency for screwing the screw member is further increased.

Another objective of this invention is to provide the screw member having two different thread angles formed on the sharp-edged thread, wherein the first thread section has at least one recessed section such that the first thread section is easier to cut a rigid material. Accordingly, the work efficiency for screwing the screw member is further increased.

The screw member in accordance with an aspect of the present invention comprises a screw shank portion and a thread portion provided thereon. The screw shank portion has a bottom end formed with a tapered section, and a top end formed with a screw head portion. The thread portion is provided on an outer circumference of the screw shank portion. The thread portion includes a first thread section proximate the tapered section, and a second thread section proximate the screw head portion. The first thread section has a first thread angle of a sharp-edged thread smaller than a second thread angle of the second thread section such that the first thread section is easier to cut a rigid material.

In a separate aspect of the present invention, the thread portion includes a third thread section.

In a further separate aspect of the present invention, the third thread section connects between the first thread section and the second thread section.

In a further separate aspect of the present invention, the first thread section further includes a series of recessed sections formed thereon.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side elevational view illustrating a conventional screw member in accordance with the prior art;

FIG. 2 is a side elevational view illustrating a screw member having different thread angles in accordance with a first embodiment of the present invention;

FIG. 3 is an enlarged view, in FIG. 2, illustrating a thread portion of the screw member having different thread angles in accordance with the first embodiment of the present invention;

FIG. 4 is a fragmented, perspective view, depicted in FIG. 3, illustrating the thread portion of the screw member having different thread angles in accordance with a first embodiment of the present invention;

FIG. 5 is a side elevational view illustrating the screw member engaged with a tool member for drilling operation in accordance with the first embodiment of the present invention in drilling operation; and

FIG. 6 is a side elevational view illustrating the screw member having different thread angles in accordance with a second embodiment of the present invention.

### DETAILED DESCRIPTION OF THE INVENTION

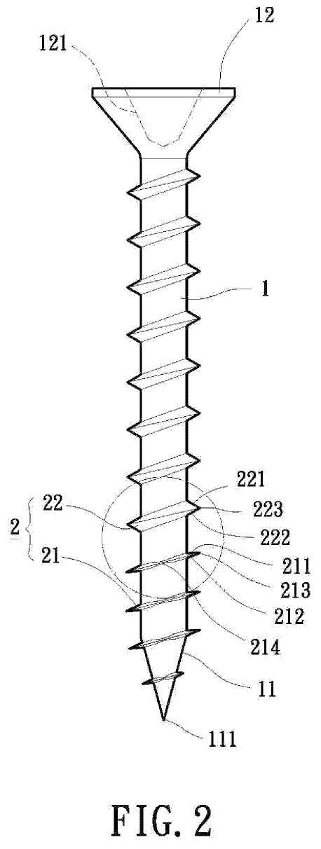

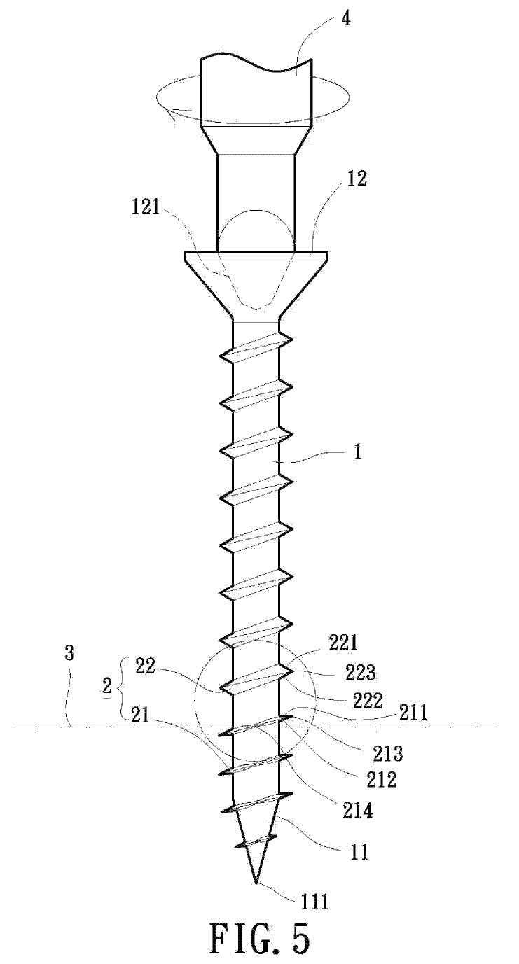

Referring initially to FIG. 2, a side elevational of a screw member having different thread angles in accordance with a first embodiment of the present invention is illustrated. The screw member includes a screw shank portion 1 and a thread portion 2 provided thereon. Construction of the screw shank portion 1 shall now be described in further detail, with reference to FIG. 2. The screw shank portion 1 is upright in form and presents a shank body. The screw shank portion 1 has a bottom end formed with a tapered section 11, and a top end formed with a screw head portion 12. The tapered section 11 is further formed with a sharp tip 111 at its distal end for digging a surface of a plank 3 (as best shown in FIG. 5) or the like. In drilling operation, the tapered section 11 may cause an initially drilling effect on the surface of the plank 3 by means of an appropriate pressing force. Preferably, the screw head portion 12 has a recessed structure of an actuating slot or socket 121 for receiving a tip of the tool member 4 or the like in screwing operation. The actuating slot or socket 121 can be configured to have various types, including a one-way slot, a cross slot and a square socket. Accordingly, various types of the tips of the tool members 4 such as a flat tip, a cross-headed tip or a square-headed tip can be used to actuate the screw member of the preferred embodiment without departing from the spirit of the present invention. By way of example, a screwdriver or the like can be used to rotate the screw member in inserting (i.e. tightening) into a screw hole or removing (i.e. loosening) it from the screw hole. Consequently, the screw shank portion 1 can be inserted into or drawn out from the screw hole.

With continued reference to FIG. 2, construction of the thread portion 2 shall now be described in further detail. Preferably, the thread portion 2 may be formed by a thread rolling procedure, a die pressing procedure or a casting procedure. The thread portion 2 is provided on an outer circumference of the screw shank portion 1. In a preferred embodiment, integrally formed on the screw shank portion 1 is the thread portion 2 which extends along an outer circumference of the screw shank portion 1 from the screw head portion 12 to the tapered section 11. The thread portion 2 is in the form of spiral and is used to cut the material of the plank 3, as best shown in FIG. 5. In the first embodiment, the thread portion 2 includes a first thread section 21 proximate the screw head portion 12, and a second thread section 22 proximate the tapered section 11. In a preferred embodiment, the first thread section 21 is located and successively extended on the tapered section 11 and a predetermined section adjacent to the tapered section 11. In another preferred embodiment, pitches of the first thread section 21 are equi-spaced on the screw shank portion 1. Similarly, pitches of the second thread section 22 are also equi-spaced on the screw shank portion 1. In a preferred embodiment, the first thread section 21 connects with the second thread section 22. In an alternative embodiment, the first thread section 21 disconnects from the second thread section 22.

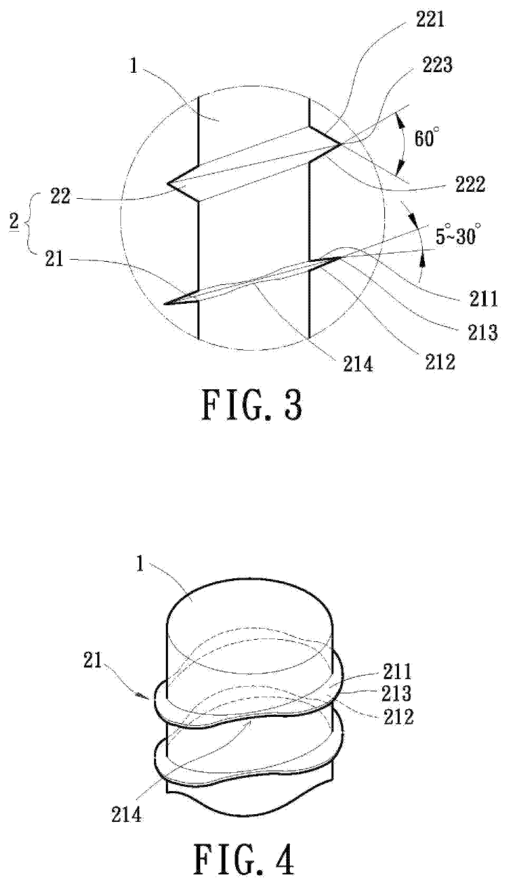

Turning now to FIGS. 3 and 4, side elevational views of the thread portion of the screw member in accordance with the first embodiment of the present invention are illustrated. The first thread section 21 includes an upper cutting surface 211, a lower cutting surface 212, a sharp-edged thread 213 and a plurality of recessed sections 214. The upper cutting surface 211 is disposed at an upper side of the first thread section 21 while the lower cutting surface 212 is disposed at a lower side of the first thread section 21. Preferably, each of the upper cutting surface 211 and lower cutting surface 212 is a curve surface and has an inclination to the sharp-edged thread 213. The upper cutting surface 211 and lower cutting surface 212 constitute the sharp-edged thread 213 of the first thread section 21. Formed between extended lines of the upper cutting surface 211 and lower cutting surface 212 is a first included angle of the sharp-edged thread 213 of the first thread section 21, as best shown in FIG. 3. It will be further understood that the first included angle formed between the extended lines of the upper cutting surface 211 and lower cutting surface 212 will be known as “thread angle”. In a preferred embodiment, the sharp-edged thread 213 of the first thread section 21 has a first thread angle ranging from 5 degrees to 30 degrees that may provide a relatively greater sharpness. Preferably, the sharp-edged thread 213 of the first thread section 21 has a relatively thinner thickness. Furthermore, a series of the recessed sections 214 formed on the first thread section 21 are preferably aligned in a longitudinal direction of the screw member. In drilling operation, each of the recessed sections 214 functions as a buffer section of the first thread section 21 for increasing the work efficiency. Preferably, the recessed section 214 varies in shapes, as best shown in FIG. 4.

Still referring to FIGS. 3 and 4, the second thread section 22 includes an upper cutting surface 221, a lower cutting surface 222 and a sharp-edged thread 223. The upper cutting surface 221 is disposed at an upper side of the second thread section 22 while the lower cutting surface 222 is disposed at a lower side of the second thread section 22. Preferably, each of the upper cutting surface 221 and lower cutting surface 222 is a curve surface and has an inclination to the sharp-edged thread 223. The upper cutting surface 221 and lower cutting surface 222 constitute the sharp-edged thread 223 of the second thread section 22. Formed between extended lines of the upper cutting surface 221 and lower cutting surface 222 is a second included angle (i.e. thread angle) of the sharp-edged thread 223 of the screw member. In a preferred embodiment, the sharp-edged thread 223 of the second thread section 22 has a second thread angle of 60 degrees that may provide a greater toughness. In this manner, the first thread angle of the first thread section 21 is smaller than the second thread angle of the second thread section 22 such that the first thread section 21 is easier to cut a rigid material. In addition, the second thread section 22 has a thickness greater than that of the first thread section 21 so as to provide a higher degree of strength of the thread portion 2.

Turning now to FIG. 5, a side elevational view of the thread portion of the screw member in accordance with the first embodiment of the present invention is illustrated. The screw member of the present invention is suitable for drilling the surface of the plank 3 such as a wood plank or a plastic plank. By such a structure of the screw member, the sharp tip 111 of the screw shank portion 1 is initially engaged against the surface of the plank 3. In this way, the tip of the tool member 4 is engaged with the actuating slot or socket 121 of the screw head portion 12. In drilling operation, the tool member 4 can be rotated along a clockwise direction (as shown in the directional arrow in FIG. 5). The sharp tip 111 of the screw shank portion 1 may cause an initially drilling effect on the surface of the plank 3 when starting to press and rotate the screw member. The relatively smaller thread angle of the sharp-edged thread 213 may start to cut the material of the plank 3 without any exertion when rotating the tool member 4. Meanwhile, the recessed sections 214 of the first thread section 21 may accommodate any drilling dirt occurring during drilling operation.

Still referring to FIG. 5, when completely inserting the first thread section 21 into the surface of the plank 3, the first thread section 21 may not cause any bulging or cracking effect on the surface of the plank 3 such that the quality of screwing the screw member on the plank 3 is ensured. In this circumstance, the first thread section 21 has left a cutting indent on the material of the plank 3. Subsequent to the insertion of the first thread section 21, the second thread section 22 may follow the cutting indent so as to continuously cut the material of the plank 3 by rotating the tool member 4. It would be advantageous that the insertion of the second thread section 22 may reduce the risk of causing a bulging or cracking effect on the surface of the plank 3. Once the thread portion 2 is completely inserted into the surface of the plank 3, the greater engagement of the thread portion 2 with the plank 3 is due to the fact that the second thread section 22 has a relatively greater thickness. Consequently, the screw connection of the screw member with the plank 3 is increased.

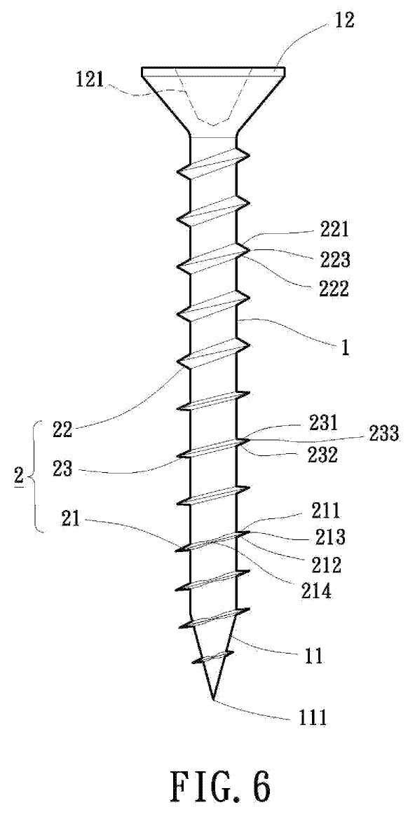

Turning now to FIG. 6, a side elevational view of the screw member in accordance with the second embodiment of the present invention is illustrated. In comparison with the first embodiment, the thread portion 2 of the second embodiment includes a first thread section 21, a second thread section 22 and a third thread section 23. Preferably, the third thread section 23 is disposed between the first thread section 21 and second thread section 22. In the second embodiment, the third thread section 23 connects between the first thread section 21 and second thread section 22. Similarly, the third thread section 23 includes an upper cutting surface 231, a lower cutting surface 232 and a sharp-edged thread 233. The upper cutting surface 231 is disposed at an upper side of the third thread section 23 while the lower cutting surface 232 is disposed at a lower side of the third thread section 23. Preferably, each of the upper cutting surface 231 and lower cutting surface 232 is a curve surface and has an inclination to the sharp-edged thread 233. The upper cutting surface 231 and lower cutting surface 232 constitute the sharp-edged thread 233 of the third thread section 23. Formed between extended lines of the upper cutting surface 231 and lower cutting surface 232 is a third included angle of the sharp-edged thread 233 of the third thread section 23. In a preferred embodiment, the sharp-edged thread 233 of the third thread section 23 has a third thread angle ranging from 30 degrees to 60 degrees. More preferably, the third thread angle of the sharp-edged thread 233 is approximately 45 degrees.

With continued reference to FIG. 6, the third thread angle of the third thread section 23 is smaller than the second thread angle of the second thread section 22 but greater than the first thread angle of the first thread section 21. In addition, the third thread section 23 has a thickness smaller than that of the second thread section 22 but greater than that of the first thread section 21. In a preferred embodiment, the third thread section 23 may disconnect from one or both of the first thread section 21 and second thread section 22. In drilling operation, it would be advantageous that the combination of the first thread section 21, second thread section 22 and third thread section 23 is suitable for applying to cut a rigid material.

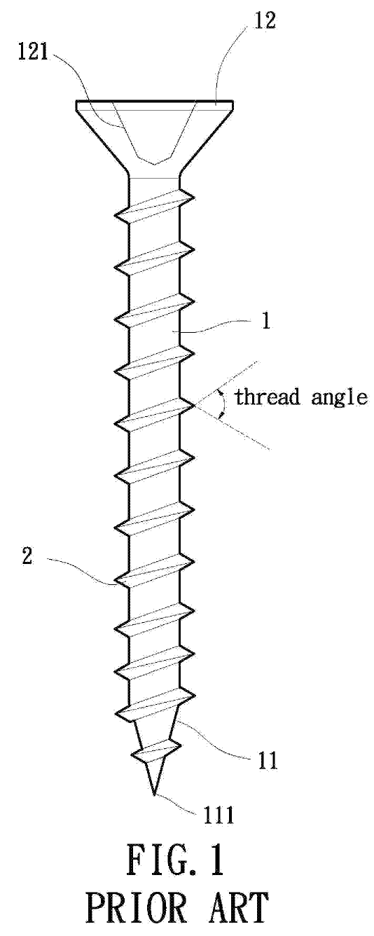

As has been discussed above, the conventional screw member has a uniform thread angle of the sharp-edged thread, as shown in FIG. 1, such that a greater exertion must be applied in drilling the surface of the plank. Disadvantageously, there is a good possibility of causing the bulging or cracking effect on the surface of the plank. Conversely, the thread portion 2 has different thread angles of the sharp-edged threads provided on the first thread section 21 and second section 22, as best shown in FIG. 2, so as to cut the material of the plank 3 without any greater exertion. In addition, the first thread section 21 further includes a series of the recessed sections 214 functioning as a buffer section for increasing the work efficiency.

Although the invention has been described in detail with reference to its presently preferred embodiment, it will be understood by one of ordinary skill in the art that various modifications can be made without departing from the spirit and scope of the invention, as set forth in the appended claims.

What is claimed is:

1. A screw member structure, comprising:
a screw shank portion having a bottom end formed with a tapered section, and a top end formed with a screw head portion; and
a thread portion provided on an outer circumference of the screw shank portion, the thread portion including a first thread section having a first thread angle and a second thread section having a second thread angle different from the first thread angle, the first thread section being proximate the tapered section of the screw shank portion while the second thread section being proximate the screw head portion of the screw shank portion.

2. The screw member structure as defined in claim 1, wherein the first thread section includes an upper cutting surface and a lower cutting surface which constitute a sharp-edged thread.

3. The screw member structure as defined in claim 2, wherein the first thread angle is formed between extended lines of the upper cutting surface and the lower cutting surface, and is ranging from 5 degrees to 30 degrees.

4. The screw member structure as defined in claim 1, wherein the first thread section further includes a plurality of recessed sections formed thereon.

5. The screw member structure as defined in claim 4, wherein the recessed section varies in shapes.

6. The screw member structure as defined in claim 1, wherein the second thread section includes an upper cutting surface and a lower cutting surface which constitute a sharp-edged thread.

7. The screw member structure as defined in claim 6, wherein the second thread angle formed between extended lines of the upper cutting surface and the lower cutting surface is approximately 60 degrees.

8. The screw member structure as defined in claim 1, wherein the thread portion further includes a third thread section disposed between the first thread section and the second thread section, the third thread section includes an upper cutting surface and a lower cutting surface which constitute a sharp-edged thread.

9. The screw member structure as defined in claim 8, wherein the third thread section has a third thread angle greater than the first thread angle of the first thread section but less than the second thread angle of the second thread section.

10. The screw member structure as defined in claim 8, wherein the third thread angle is ranging from 30 degrees to 60 degrees.

11. The screw member structure as defined in claim 8, wherein third thread section connects between the first thread section and the second thread section, or disconnects from one or both of the first thread section and the second thread section.

12. The screw member structure as defined in claim 1, the tapered section of the screw shank portion includes a sharp tip to engage against a surface of a plank.

13. The screw member structure as defined in claim 1, wherein the screw head portion includes an actuating slot or socket for receiving a tip of a tool member.

14. The screw member structure as defined in claim 13, wherein the actuating slot or socket is configured to have various types, including a one-way slot, a cross slot and a square socket.

15. The screw member structure as defined in claim 1, wherein the first thread angle of the first thread section is less than the second thread angle of the second thread section.
